(19) United States
(12) Patent Application Publication
(10) Pub. No.: US 2026/0310698 A1
(43) Pub. Date: Oct. 8, 2026

(54) SYSTEMS AND METHODS FOR AUTOMATED PROMPT AND RESPONSE MODERATION THROUGH GENERALIZED AUTONOMOUS INTELLIGENT AGENTS

(71) Applicant: Abysius Inc., Minnetonka, MN (US)

(72) Inventor: Kevin Friesth, Fort Dodge, IA (US)

(73) Assignee: Abysius Inc., Minnetonka, MN (US)

(21) Appl. No.: 19/637,383

(22) Filed: Apr. 2, 2026

Related U.S. Application Data
(60) Provisional application No. 63/782,263, filed on Apr. 2, 2025.

(51) Int. Cl. G06F 16/3329; G06F 40/30

(52) U.S. Cl. CPC G06F 16/33295; G06F 40/30

(57) ABSTRACT

Systems and methods provide a framework for the automated evaluation of user prompts to identify impermissible intents and, in response to identifying an impermissible intent, performing any required remedial actions. Further, these systems and methods provide for automated evaluation of responses generated through domain-specific artificial intelligence (AI) models and according to applicable rules and standards to modify these responses prior to dissemination to users.

### CROSS-REFERENCE TO RELATED APPLICATIONS

The present patent application claims the priority benefit of U.S. Provisional Patent Application Number 63/782,263 filed Apr. 2, 2025, the disclosures of which are incorporated by reference herein.

### FIELD

The present disclosure relates generally to systems and methods for the automated evaluation of user prompts to identify impermissible intents and, in response to identifying an impermissible intent, performing any required remedial actions. Further, these systems and methods further provide for automated evaluation of responses generated through domain-specific artificial intelligence (AI) models and according to applicable rules and standards to modify these responses prior to dissemination to users.

### SUMMARY

Disclosed embodiments provide a framework for the automated evaluation of user prompts to identify impermissible intents and, in response to identifying an impermissible intent, performing any required remedial actions. Further, this framework provides for automated evaluation of responses generated through domain-specific artificial intelligence (AI) models and according to applicable rules and standards to modify these responses prior to dissemination to users. According to some embodiments, a computer-implemented method is provided. The computer-implemented method comprises detecting a user prompt associated with a user. The user prompt is received during an ongoing communications session between a user and a generalized autonomous intelligent agent. The computer-implemented method further comprises processing the user prompt through the generalized autonomous intelligent agent to detect an intent. The computer-implemented method further comprises identifying a set of applicable rules corresponding to different intents. The set of applicable rules defines one or more impermissible intents and one or more ethical limitations associated with a set of user characteristics corresponding to the user. The computer-implemented method further comprises transmitting the user prompt to a set of domain-specific artificial intelligence models to solicit a response to the user prompt. The user prompt is transmitted as a result of the intent not corresponding to the one or more impermissible intents. Furthermore, when the user prompt is i received by the set of domain-specific artificial intelligence models, the set of domain-specific artificial intelligence models collaboratively processes the user prompt to generate a set of responses. The computer-implemented method further comprises modifying the set of responses according to the set of applicable rules to generate a tailored response. The tailored response is devoid of content corresponding to the one or more ethical limitations. The computer-implemented method further comprises updating an interface associated with the ongoing communications session to provide the tailored response.

In some embodiments, the computer-implemented method further comprises detecting a new user prompt. The new user prompt corresponds to an impermissible intent. The computer-implemented method further comprises automatically rejecting the new user prompt. The new user prompt is automatically rejected based on the impermissible intent and the set of applicable rules.

In some embodiments, the one or more ethical limitations correspond to permissible locations from which user prompts corresponding to the intent are processable. Furthermore, the user prompt is transmitted to the set of domain-specific artificial intelligence models as a result of the user prompt being submitted from a permissible location.

In some embodiments, the one or more ethical limitations correspond to permissible user organizations authorized to submit user prompts corresponding to the intent. Furthermore, the user prompt is transmitted to the set of domain-specific artificial intelligence models as a result of the user being associated with a permissible user organization.

In some embodiments, the computer-implemented method further comprises detecting a new user prompt. The new user prompt corresponds to an impermissible intent. The computer-implemented method further comprises disabling further user interaction with the generalized autonomous intelligent agent as a result of the new user prompt corresponding to the impermissible intent.

In some embodiments, the computer-implemented method further comprises detecting a new user prompt. The new user prompt corresponds to an impermissible intent. The computer-implemented method further comprises transmitting the new user prompt to one or more external entities to address the impermissible intent.

In some embodiments, modifying the set of responses further comprises performing an emotion-informed risk assessment of the set of responses to identify one or more emotional aspects associated with the set of responses. Further, modifying the set of responses further comprises modifying the set of responses according to the one or more emotional aspects.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a generalized autonomous intelligent agent dynamically processes user prompts according to applicable rules and standards to identify impermissible intents and accordingly perform any required remedial actions in accordance with at least one embodiment;

FIG. 2 shows an illustrative example of an environment in which an autonomous ethical oversight module implemented by a generalized autonomous intelligent agent dynamically processes user prompts and responses from different domain-specific AI models to identify impermissible intents and tailor responses according to applicable rules and standards in accordance with at least one embodiment;

FIG. 3 shows an illustrative example of a process for dynamically evaluating received user prompts to identify corresponding intents and determine whether to process these prompts according to any applicable rules and standards in accordance with at least one embodiment;

FIG. 4 shows an illustrative example of a process for dynamically evaluating responses generated by different domain-specific AI models to determine whether to modify the responses according to any applicable rules or standards prior to providing a tailored response to a user prompt in accordance with at least one embodiment; and

FIG. 5 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing preferred examples of embodiments. It is understood that various changes can be made in the function and arrangement of elements without departing from the spirit and scope as set forth in the appended claims.

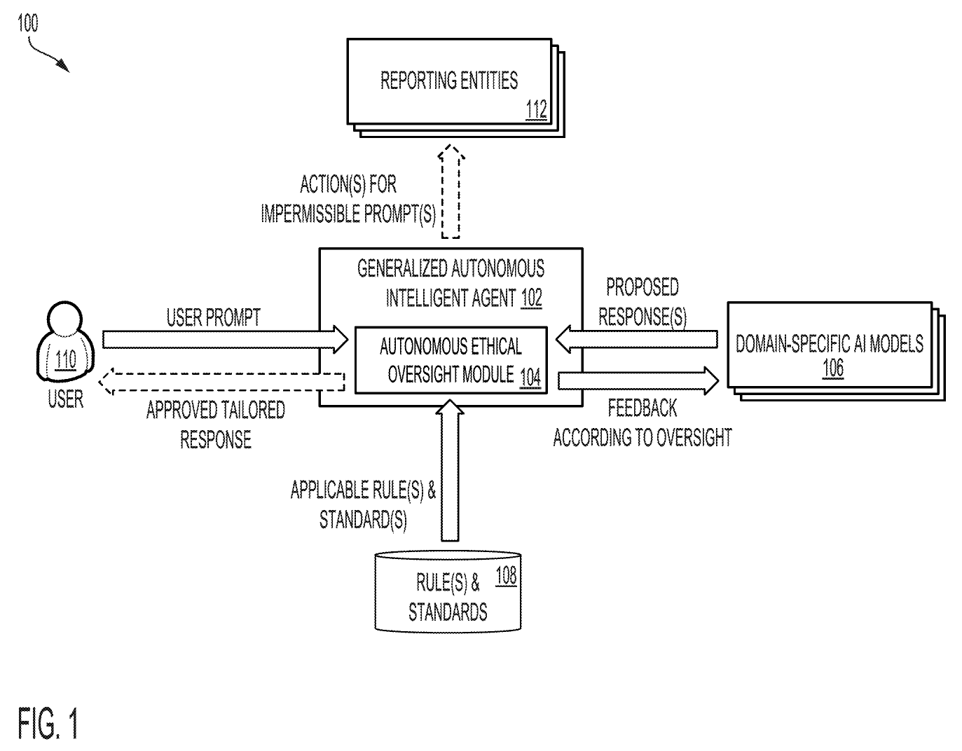

FIG. 1 shows an illustrative example of an environment 100 in which a generalized autonomous intelligent agent 102 dynamically processes user prompts according to applicable rules and standards to identify impermissible intents and accordingly perform any required remedial actions in accordance with at least one embodiment. In the environment 100, a generalized autonomous intelligent agent 102 receives a user prompt from a user 110 to obtain an output that satisfies this user prompt. In an embodiment, the generalized autonomous intelligent agent 102 is dynamically trained to implement and leverage domain-specific AI models 106 to provide sophisticated and refined responses to user prompts and other requests. The generalized autonomous intelligent agent 102 may be dynamically trained using fuzzy logic with a covariance matrix adaptation evolution strategy (CMA-ES) to derive a set of values corresponding to different hyperparameters or other coefficients that, in combination, are used to derive an output given a sample input. For this set of values, a set of weights may be derived through random search, grid search, Bayesian optimization, or other hyperparameter optimization mechanism to fine-tune the hyperparameters of the generalized autonomous intelligent agent 102.

The initial training of the generalized autonomous intelligent agent 102 may be performed using human-in-the-loop (HITL) training techniques. For instance, the generalized autonomous intelligent agent 102 may be dynamically trained using a dataset comprising a large corpus of sample prompts (e.g., historical prompts, hypothetical prompts, combinations of historical and hypothetical prompts, etc.), sample embeddings corresponding to the sample prompts, and sample responses to the sample prompts (e.g., historical responses, hypothetical responses, combinations of historical and hypothetical responses, etc.). The generalized autonomous intelligent agent 102 may process the sample prompts included in the dataset to generate a set of outputs (e.g., responses or other data outputs) corresponding to these sample prompts. Through HITL, an evaluator may compare the set of outputs generated by the generalized autonomous intelligent agent 102 to the sample outputs from the dataset (i.e., expected outputs) to rank the generated outputs and provide corrections to these generated outputs, as necessary.

As illustrated in FIG. 1, the generalized autonomous intelligent agent 102 may leverage a set of domain-specific AI intent models 106 to generate responses to obtained user prompts. The set of domain-specific AI models 106 is dynamically trained to provide responses to prompts associated with specific knowledge domains. For instance, the generalized autonomous intelligent agent 102 may use one or more automated machine learning (AutoML) systems to generate a set of different domain-specific AI models that may be trained according to assigned domains and that incorporate different sources of knowledge associated with these domains (e.g., reference texts and manuals, domain-specific databases, training datasets, etc.). To generate this set of domain-specific AI models 106, the one or more AutoML systems may leverage various libraries that correspond to different types of machine learning models. For instance, the one or more AutoML systems may generate the set of domain-specific AI models 106 using recurrent neural networks (RNN), convoluted neural networks (CNN), long short-term memory (LSTM), k-means clustering algorithms, fuzzy c-means (FCM) algorithms, expectation-maximization (EM) algorithms, hierarchical clustering algorithms, density-based spatial clustering of applications with noise (DBSCAN) algorithms, genetic algorithms, backpropagation, reinforcement learning, decision trees, linear classification, anomaly detection, and the like. In an embodiment, each domain-specific AI model of the set of domain-specific AI models 106 is dynamically trained through knowledge distillation, wherein the generalized autonomous intelligent agent 102 can dynamically obtain different sources of knowledge associated with the particular domain for which the domain-specific AI model is to be implemented and transfers these sources of knowledge to the new domain-specific AI model. In some instances, each domain-specific AI model may be trained through Kolmogorov-Arnold networks (KAN) according to the Kolmogorov-Arnold representation theorem. Additionally, or alternatively, certain domain-specific AI models may be trained to form multilayer perceptrons (MLP). Thus, the set of domain-specific AI models 106 may include different domain-specific AI models that are dynamically trained and implemented according to knowledge distillation, KAN, and/or MLP configurations.

In an embodiment, the set of domain-specific AI models 106 is organized according to different clusters or committees that correspond to specific domains or other areas of influence. For instance, the generalized autonomous intelligent agent 102 may define a cluster or committee of domain-specific AI models 106 that, collectively, can process prompts or requests corresponding to aircraft design, incorporating domain-specific AI models corresponding to aerodynamic principles, structural analysis, propulsion and thermal analysis, control systems, and the like. As another illustrative example, the generalized autonomous intelligent agent 102 may define a cluster or committee of domain-specific AI models 106 that, collectively, can process prompts or requests corresponding to foreign policy, incorporating domain-specific AI models corresponding to world history, political theory, military doctrines, and the like. To maintain these different clusters or committees, the generalized autonomous intelligent agent 102 may assign specific keywords or disciplines to the different clusters or committees in order to maintain a clear division of labor amongst the different domain-specific AI models 106 implemented by the generalized autonomous intelligent agent 102. Each domain-specific AI model assigned to a particular cluster or committee may be associated with the specific keywords or disciplines such that, when the generalized autonomous intelligent agent 102 selects the particular cluster or committee to review a given prompt and generate a response to the prompt, the prompt may be provided to each of the domain-specific AI models 106 assigned to the cluster or committee.

To train a domain-specific AI model, the generalized autonomous intelligent agent 102 may use fuzzy logic, along with particle swarm optimization (PSO) and CMA-ES with reinforcement learning, for a particular subdiscipline assigned to the model. In some instances, the generalized autonomous intelligent agent 102 may apply a curriculum learning method according to any sources of knowledge associated with the subdiscipline for which the domain-specific AI model is being trained. For instance, using an initial dataset including sample prompts and expected outputs associated with a particular subdiscipline, the generalized autonomous intelligent agent 102 may evaluate the outputs generated by the domain-specific AI model to determine whether these outputs comport with the expected outputs defined in the dataset. If the generated outputs comport with the expected outputs, the generalized autonomous intelligent agent 102 may dynamically adjust the curriculum (i.e., dataset) to incorporate additional subdiscipline resources that may be more complex in nature and involve advanced concepts related to the subdiscipline. The domain-specific AI model may be evaluated against this new dataset to further enhance the capabilities of the domain-specific AI model in processing prompts related to its subdiscipline.

Application of the curriculum learning method, in an embodiment, includes obtaining myriad training materials from different external data sources for training of the domain-specific AI models 106. For instance, the generalized autonomous intelligent agent 102 may aggregate data from various external data sources, including text-based reference materials, audiovisual recordings, images, news articles, scholarly journals, etc. from diverse domains and sources. Further, the generalized autonomous intelligent agent 102 may utilize web scraping, application programming interfaces (APIs), and any accessible datasets (public and/or private) to obtain additional data that may be used to train the domain-specific AI models 106 according to their assigned domains. The generalized autonomous intelligent agent 102 may convert the obtained data into corresponding reference embeddings that may be incorporated into the initial datasets used to train the domain-specific AI models 106. If the generated outputs comport with the expected outputs, the generalized autonomous intelligent agent 102 may dynamically adjust the curriculum (i.e., dataset) to incorporate additional reference embeddings corresponding to more advanced reference materials from the external data sources. The domain-specific AI model may be evaluated against this new dataset, as described above, to further enhance the domain-specific AI model.

In an embodiment, the generalized autonomous intelligent agent 102 is further trained to identify, based on an evaluation of a received user prompt or request, a cluster or committee of domain-specific AI models to which a response to the user prompt may be solicited. For instance, the generalized autonomous intelligent agent 102 may be trained to employ natural language processing (NLP) techniques (including named entity recognition (NER) and dependency parsing) for converting received user prompts into sets of prompt embeddings that may be used to identify the appropriate cluster or committee of domain-specific AI models that may be leveraged to generate a response to the prompt. For instance, the generalized autonomous intelligent agent 102 may be dynamically trained using a dataset of sample prompts and sample embeddings corresponding to these sample prompts. Using fuzzy logic with CMA-ES, the generalized autonomous intelligent agent 102 may be initialized using a set of coefficients or hyperparameters. The generalized autonomous intelligent agent 102 may process the dataset of sample prompts and corresponding embeddings to generate an output. This output may specify, for each sample prompt included in the dataset, a predicted set of embeddings. This output may be compared to the sample embeddings defined in the dataset for each of the data points (e.g., sample prompts) to identify any inaccuracies or other errors.

If the output of the generalized autonomous intelligent agent 102 does not satisfy one or more criteria, one or more coefficients or hyperparameters of the generalized autonomous intelligent agent 102 may be iteratively updated to generate a new iteration of the generalized autonomous intelligent agent 102. This new iteration of the generalized autonomous intelligent agent 102 may be used to process the aforementioned training dataset, as well as any additional data points or other datasets to generate a new output for each data point in the training dataset. In some instances, an optimization algorithm may be used to iteratively update the one or more coefficients of the set of coefficients associated with the generalized autonomous intelligent agent 102. The new outputs generated by the generalized autonomous intelligent agent 102 may be evaluated to determine whether the new outputs satisfy the one or more criteria. This process of updating the set of coefficients associated with the generalized autonomous intelligent agent 102 according to the one or more criteria may be performed iteratively until an iteration of the generalized autonomous intelligent agent 102 is produced that satisfies the one or more criteria.

Once the generalized autonomous intelligent agent 102 is dynamically trained to convert received user prompts into different sets of embeddings using NLP techniques and to use these sets of embeddings to identify which cluster or committee of domain-specific AI models may be leveraged to generate responses to these user prompts, the generalized autonomous intelligent agent 102 may be integrated with an agent interface through which users (such as user 110) may begin submitting new prompts. The agent interface, in an embodiment, is implemented through a web portal and/or native application executing on a user computing device. Through the agent interface, the user 110 may submit their prompt for, or otherwise interact with, the generalized autonomous intelligent agent 102.

In an embodiment, the generalized autonomous intelligent agent 102 maintains a world knowledge graph representation of the different clusters or committees of domain-specific AI models that may be leveraged to generate responses to user prompts. This world knowledge graph may be implemented through a data structure that represents the different domain-specific AI models 106 as individual nodes and any corresponding relationships using edges. The world knowledge graph may further denote the different knowledge domains or other areas of influence associated with each of these individual nodes, which may be used to define the different clusters or committees of domain-specific AI models implemented by the generalized autonomous intelligent agent 102. The world knowledge graph, in an embodiment, is further propagated to the individual domain-specific AI models 106 to enhance cross-domain knowledge sharing and emergent behavior as new user prompts are processed. In an embodiment, the world knowledge graph is implemented at a central processing unit (CPU) layer of a generalized autonomous intelligent agent system that implements the generalized autonomous intelligent agent 102 and the different domain-specific AI models 106. This may allow for efficient identification a cluster or committee of domain-specific AI models that may be leveraged for generation of one or more responses to a user prompt. By maintaining the world knowledge graph at the CPU layer of the generalized autonomous intelligent agent system, other computational resources of the generalized autonomous intelligent agent system (such as graphics processing units (GPUs), tensor processing units (TPUs), neural processing units (NPUs), language processing units (LPUs), etc.) may be reserved for more extensive tasks, including the training of the generalized autonomous intelligent agent 102 and of the domain-specific AI models 106, the processing of any user prompts according to an identified domain, the generation of responses to user prompts, and any other computationally intensive operation described herein.

In an embodiment, in response to a user prompt received through the agent interface, the generalized autonomous intelligent agent 102 may process the user prompt using NLP techniques (such as those described above) to convert the user prompt into a set of prompt embeddings. As noted above, to maintain different clusters or committees of domain-specific AI models corresponding to different knowledge domains, the generalized autonomous intelligent agent 102 may assign specific keywords or disciplines to the different clusters or committees in order to maintain a clear division of labor amongst the different domain-specific AI models 106 implemented by the generalized autonomous intelligent agent 102. The generalized autonomous intelligent agent 102, through the world knowledge graph, may compare the set of prompt embeddings to these specific keywords or disciplines to identify the appropriate cluster or committee of domain-specific AI models that may be leveraged to generate a response to the user prompt.

In an embodiment, the set of domain specific AI models 106 and the specialized agents are implemented using computing resources that may be scalable on demand, whereby additional resources may be dynamically implemented in the event of greater resource demand (e.g., data spikes, more stringent bandwidth requirements to limit latency, etc.). In an embodiment, the generalized autonomous intelligent agent 102 dynamically monitors resource utilization of each of the domain specific AI models 106 to determine whether additional domain specific AI model instances are required for generating responses to different prompts. For instance, if the generalized autonomous intelligent agent 102 determines that a particular domain-specific AI model is failing to satisfy certain performance requirements (e.g., the model is unable to return responses within a threshold period of time, the model is experiencing an input load that exceeds a load threshold, the resources used to implement the model are inoperative or otherwise unavailable for execution of the model, etc.), the generalized autonomous intelligent agent 102 may dynamically provision additional computing resources for instantiation of a new domain-specific AI model that may supplement or replace the particular domain-specific AI model. This new domain-specific AI model may be automatically added to the cluster or committee of domain-specific AI models that the original domain-specific AI model was a member of.

In an embodiment, each cluster or committee of domain-specific AI models can include additional instances of the different domain-specific AI models that comprise the cluster or committee. These additional instances of the different domain-specific AI models may provide redundancy in the event that a particular domain-specific AI model is unable to process new prompts (e.g., the model is failing particular latency thresholds, the model is inoperative or otherwise unavailable, the model is experiencing a spike in demand, etc.). In an embodiment, upon identifying the appropriate cluster or committee of domain-specific AI models that may be leveraged to generate a response to the user prompt, the generalized autonomous intelligent agent 102 may dynamically evaluate the performance of each of the domain-specific AI models that comprise the cluster or committee to identify the particular set of domain-specific AI models to be used for processing the user prompt. This may include selection of particular instances of the different domain-specific AI models according to different performance metrics associated with these instances (e.g., latency, input load, memory utilization, processor utilization, etc.). Based on this evaluation, the generalized autonomous intelligent agent 102 may select the different domain-specific AI model instances within the cluster or committee that may be leveraged for processing of the user prompt.

Once the generalized autonomous intelligent agent 102 has identified the appropriate cluster or committee of domain-specific AI models for processing of the user prompt, the generalized autonomous intelligent agent 102 may transmit the user prompt to each of the domain-specific AI models associated with the cluster or committee to solicit responses to the user prompt. In an embodiment, the domain-specific AI models associated with a particular cluster or committee may individually process an obtained user prompt to generate a response according to the knowledge domain of the domain-specific AI model. The execution of the different domain-specific AI models of a particular cluster or committee may be performed in parallel such that each domain-specific AI model may simultaneously process a user prompt according to its corresponding knowledge domain. The outputs from each of these domain-specific AI models may be circulated within the cluster or committee according to the world knowledge graph to further refine these outputs and/or leverage these outputs to converge towards a finalized response to the user prompt. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains. Each domain-specific AI model may also monitor the performance of any downstream domain-specific AI model instances to select the appropriate domain-specific AI model instances to which an output may be provided for further processing.

In an embodiment, the generalized autonomous intelligent agent 102 is implemented using the learning intelligent distribution agent (LIDA) architecture, which is used to process myriad outputs from different domain-specific AI models 106 to generate a response to a user prompt. The generalized autonomous intelligent agent 102, in an embodiment, implements one or more special-purpose modules that may evaluate any responses generated by the one or more domain-specific AI models associated with the selected cluster or committee to generate a comprehensive response to the user prompt. For instance, if two or more domain-specific AI models produce conflicting responses to a user prompt, the generalized autonomous intelligent agent 102, through the one or more special-purpose modules implemented through the LIDA architecture, may dynamically weigh each response according to the intent expressed by the user 110 in their user prompt and the particular knowledge domains of the domain-specific AI models submitting proposed responses.

In an embodiment, and as illustrated in FIG. 1, the generalized autonomous intelligent agent 102 implements an autonomous ethical oversight module 104 that is configured to dynamically evaluate user prompts to ensure that these user prompts comport with any applicable ethical rules and/or standards to prevent any misuse of the generalized autonomous intelligent agent 102. In an embodiment, the autonomous ethical oversight module 104, in response to a user prompt, may access a rules and standards repository 108 to identify and obtain any applicable rules and/or standards that may be used to evaluate the user prompt. The rules and standards maintained within the rules and standards repository 108 may specify what intents may be processed by the generalized autonomous intelligent agent 102 as well as any actions that may be performed in the event that a user submits an impermissible prompt through the agent interface. These ethical rules or standards may be specific to certain users or user characteristics. For instance, these ethical rules or standards may correspond to the location of the user 110 (e.g., the ethical rules or standards may correspond to local laws and regulations, etc.). As another example, these ethical rules or standards may correspond to a user’s organization (i.e., employer, etc.). In some instances, the ethical rules or standards may correspond to specific intents that may have questionable or harmful ethical and/or moral ramifications (e.g., self-harm, significant potential for harm to others, etc.).

In an embodiment, the ethical rules and standards that may be applicable to the user prompt are determined based on the user’s particular role. For instance, when the user 110 initiates a communications session with the generalized autonomous intelligent agent 102, the generalized autonomous intelligent agent 102 may assess the user’s role within an organization or other entity to identify the rules and standards that may be applicable to any user prompts submitted by the user 110. These rules and standards may be used to identify the permissible intents that may be communicated by the user 110 through their user prompts. The generalized autonomous intelligent agent 102, through an authentication layer, may evaluate a user profile associated with the user 110 to detect the user’s role within an organization or other entity and, based on this role, identify the applicable rules and/or standards from the rules and standards repository 108. The authentication layer may be implemented using a common user database that provides login simplicity for users and to further reinforce a user interaction code of conduct, whereby users may be held accountable for their interactions with the generalized autonomous intelligent agent 102 such as through limitations of use, suspensions, and the like. The authentication layer may be configured using the Django authentication system framework for identity and access management and for the implementation of a password-less, biometric-based authentication. Through the authentication layer, a user 110 may register a new account with the generalized autonomous intelligent agent 102 and provide their credentials (e.g., biometric information, cryptographic tokens, etc.) that may be authenticated by the authentication layer and evaluated to determine whether the user 110 is authorized to interact with the generalized autonomous intelligent agent 102 (e.g., the user is not subject to a suspension, limitation of use, or other restriction, etc.).

In response to a user prompt, the autonomous ethical oversight module 104 may autonomously evaluate the user prompt to determine whether the user prompt comports with applicable ethical rules and standards from the rules and standards repository 108. For instance, the autonomous ethical oversight module 104, using the aforementioned NLP techniques, may automatically parse the user prompt to identify particular terms that may be used to determine an intent expressed by the user 110. If the autonomous ethical oversight module 104 determines that the determined intent does not comport with the applicable ethical rules and standards, the autonomous ethical oversight module 104 may determine what actions may be taken as a result of the impermissible prompt. For example, as illustrated in FIG. 1, the autonomous ethical oversight module 104 may transmit to one or more reporting entities 112, an indication that the user 110 has submitted a user prompt corresponding to an impermissible intent.

The one or more reporting entities 112 may be identified according to the applicable rules and/or standards and any user characteristics associated with the user 110. For instance, if the user prompt associated with an impermissible intent was communicated from a computing device associated with the user’s employer, the autonomous ethical oversight module 104 may automatically transmit a notification to this employer to indicate the submission of this user prompt. This may allow the employer to address the user’s submission of an impermissible user prompt. In some instances, if the autonomous ethical oversight module 104 determines that the user prompt is associated with an impermissible intent corresponding to illicit activity, the autonomous ethical oversight module 104 may transmit a notification to law enforcement agencies that may address the user’s submission of an impermissible user prompt. In some instances, if the user 110 submits an impermissible user prompt, the autonomous ethical oversight module 104 may use an authentication layer of the generalized autonomous intelligent agent 102 to update the common user database implemented through the authentication layer to suspend the user, limit the user’s interactions with the generalized autonomous intelligent agent 102, or otherwise perform any required disciplinary action.

In an embodiment, if the autonomous ethical oversight module 104 determines that the user prompt satisfies a corresponding set of applicable rules and/or standards (as defined in the rules and standards repository 108), the generalized autonomous intelligent agent 102 may convert the user prompt into a set of prompt embeddings that are used to identify a cluster or committee of domain-specific AI models that can be solicited to obtain initial responses to the user prompt. The generalized autonomous intelligent agent 102 may compare the set of prompt embeddings to the specific keywords or disciplines assigned to each cluster or committee of domain-specific AI models to identify the appropriate cluster or committee of domain-specific AI models that may be leveraged to generate a response to the user prompt. Once the generalized autonomous intelligent agent 102 has identified the appropriate cluster or committee of domain-specific AI models for processing of the user prompt, the generalized autonomous intelligent agent 102 may transmit the user prompt to each of the domain-specific AI models 106 associated with the cluster or committee to solicit responses to the user prompt. The different domain-specific AI models 106 within the cluster or committee may collaboratively process the user prompt according to their individual knowledge domains to generate a cohesive and comprehensive response to the user prompt. Further, each domain-specific AI model may review and refine any outputs generated by the different domain-specific AI models within a cluster or committee to ensure response accuracy.

In an embodiment, in addition to transmitting the user prompt to each of the domain-specific AI models 106 associated with the cluster or committee to solicit responses to the user prompt, the generalized autonomous intelligent agent 102 provides the applicable rules and/or standards identified by the autonomous ethical oversight module 104 to the domain-specific AI models 106. The different domain-specific AI models bwithin the cluster or committee selected by the generalized autonomous intelligent agent 102 may collaboratively process the user prompt according to the applicable rules and/or standards and generate a cohesive and comprehensive response to the user prompt that complies with the applicable rules and/or standards.

As noted above, the execution of the different domain-specific AI models 106 of a particular cluster or committee may be performed in parallel such that each domain-specific AI model may simultaneously process a user prompt according to its corresponding knowledge domain. Further, each domain-specific AI model 106 of the particular cluster or committee may simultaneously process the user prompt according to the obtained rules and/or standards to generate individual responses that comply with these rules and/or standards. The outputs from each of these domain-specific AI models 106 may be circulated within the cluster or committee according to the world knowledge graph to further refine these outputs and/or leverage these outputs to converge towards a finalized response to the user prompt. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains.

When the generalized autonomous intelligent agent 102 obtains a response from the set of domain-specific AI models 106 associated with the selected cluster or committee, the generalized autonomous intelligent agent 102 may evaluate the response to determine whether the response may be provided to the user 110. In an embodiment, the generalized autonomous intelligent agent 102 is implemented using the LIDA architecture, which is used to process the outputs from the different domain-specific AI models 106 to generate a cohesive response to the user prompt. The generalized autonomous intelligent agent 102, for instance, may dynamically weigh each response according to the intent expressed by the user 110 in their user prompt and the particular knowledge domains of the domain-specific AI models submitting proposed responses. For example, if two or more domain-specific AI models produce conflicting responses to a user prompt, the generalized autonomous intelligent agent 102, through the one or more special-purpose modules implemented through the LIDA architecture, may dynamically weigh each response according to the intent expressed by the user 110 in their user prompt and the particular knowledge domains of the domain-specific AI models submitting proposed responses.

In an embodiment, prior to providing a response to user prompt, the autonomous ethical oversight module 104 evaluates the response to ensure that the response comports with any applicable ethical rules or standards, ensuring that the generalized autonomous intelligent agent 102 and the domain-specific AI models 106 are not misused or otherwise do not cause unintended consequences. For instance, the autonomous ethical oversight module 104 may perform emotion-informed risk assessment to consider emotional aspects when evaluating risks and potential outcomes from providing the generated response to the user 110. For instance, a given response may present possible ethical dilemmas whereby, based on a user profile corresponding to the user 110, the autonomous ethical oversight module 104 may determine that providing the generated response could result in possible self-harm or other forms of harm (e.g., harm or violence to others, violation of applicable laws and regulations, violation of workplace policies, etc.). Accordingly, the autonomous ethical oversight module 104 may modify the response to remove any information or other data that may be problematic.

The emotion-informed risk assessment performed by the autonomous ethical oversight module 104 may incorporate the user’s current sentiment or emotional state. For instance, the generalized autonomous intelligent agent 102 may be trained to process different user inputs (e.g., text-based inputs, audiovisual inputs, etc.) to determine the user’s current sentiment or emotional states. As an illustrative example, the generalized autonomous intelligent agent 102, using NLP techniques, may identify any expressed keywords, phrases, or other terms from a user communication that may be indicative of the user’s expressed intent and that may be used to determine the user’s current sentiment or emotional state. As another illustrative example, the generalized autonomous intelligent agent 102 may allow the user 110 to use one or more peripheral devices (e.g., camera, scanner, etc.) implemented on their computing device to engage with the generalized autonomous intelligent agent 102 using real-time audiovisual communications. In an embodiment, the generalized autonomous intelligent agent 102 uses computer vision or other machine learning algorithm/artificial intelligence techniques to dynamically, and in real-time, process the real-time audiovisual communications associated with the user 110 to determine the user’s current sentiment or emotional state. For instance, using computer vision or other machine learning algorithm/artificial intelligence techniques, the generalized autonomous intelligent agent 102 may generate a data representation (e.g., vectors, tensors, etc.) with values representing the user 110. This data representation of the user 110 may correspond to any detected user mannerisms, eye movements, pupil dilation, body language, and the like.

In an embodiment, the generalized autonomous intelligent agent 102, using computer vision or other machine learning algorithm/artificial intelligence techniques, generates a baseline data representation of the user 110. This baseline data representation of the user 110 may denote a neutral emotional state or sentiment that represents the user’s natural communication cadence and other idiosyncrasies. Further, this baseline data representation of the user 110 may be reinforced using NLP techniques, which may be used to identify any expressed keywords, phrases, or other terms that may be indicative of the user’s expressed intent and current sentiment or emotional state. As the generalized autonomous intelligent agent 102, using computer vision or other machine learning algorithm/artificial intelligence techniques, processes a data feed comprising audiovisual communications exchanged in real-time, the generalized autonomous intelligent agent 102 may obtain new data representations of the user 110, with values representing the new biometric information associated with the user 110. The generalized autonomous intelligent agent 102 may compare these new data representations of the user 110 to the baseline data representation of the user 110 to detect any differences that may denote changes in the user’s emotional state or sentiment. For instance, certain deviations from the baseline data representation may correspond to particular emotional states or sentiments, which may be corroborated or reinforced through evaluation of additional inputs (e.g., text-based inputs, etc.).

As noted above, the autonomous ethical oversight module 104 may perform emotion-informed risk assessment to consider emotional aspects when evaluating risks and potential outcomes from providing the generated response to the user 110. In an embodiment, the autonomous ethical oversight module 104 may evaluate a given response according to the user’s current emotional state or sentiment to determine whether the given response presents possible ethical dilemmas whereby, based on the user’s current emotional state or sentiment, the autonomous ethical oversight module 104 may determine that providing the generated response could result in possible self-harm or other forms of harm (e.g., harm or violence to others, violation of applicable laws and regulations, violation of workplace policies, etc.). Accordingly, the autonomous ethical oversight module 104 may modify the response to remove any information or other data that may be problematic or otherwise degrade the user’s current emotional state or sentiment.

Once the generalized autonomous intelligent agent 102 has finalized a response for delivery to the user 110, the generalized autonomous intelligent agent 102 may communicate the response to the user 110, such as through the ongoing communications session presented through an interface implemented through an application executing on a user device or web portal. In an embodiment, the generalized autonomous intelligent agent 102 monitors subsequent user communications to obtain feedback with regard to provided response. The generalized autonomous intelligent agent 102 may continuously execute continuous reinforcement learning (CRL) using feature map attention loss (FMAL) to further reinforce and/or update the generalized autonomous intelligent agent 102 and the domain-specific AI models 106. For instance, as users provide feedback with regard to provided responses, the generalized autonomous intelligent agent 102 may determine whether these responses successfully addressed the corresponding user prompts. If a user indicates that a response is unsatisfactory (e.g., the response was incorrect, the response did not comport with the user’s expectations, the response was not responsive to the user prompt, etc.), the generalized autonomous intelligent agent 102 may evaluate this feedback to determine the areas of improvement that should be addressed to improve response accuracy. For example, if the generalized autonomous intelligent agent 102 determines that a particular domain-based AI model has provided an erroneous response according to its domain or area of influence, the generalized autonomous intelligent agent 102 may determine the source of this error and apply the aforementioned curriculum learning method to further train the domain-specific AI model according to its assigned knowledge domain. This process may include identifying additional external data sources from which to obtain additional training materials and enhancing the training dataset used to train the domain-specific AI model by incorporating these additional training materials.

In an embodiment, the generalized autonomous intelligent agent 102, through the autonomous ethical oversight module 104, further processes the feedback with regard to the provided response to determine whether the provided response resulted in a problematic outcome. For example, if the autonomous ethical oversight module 104 detects a subsequent user prompt that is violative one or more applicable rules and/or standards and the subsequent user prompt is related to the previously provided response, the autonomous ethical oversight module 104 may determine that the previously provided response included one or more elements that were problematic and that should have been removed from the previously provided response. As another illustrative example, if the autonomous ethical oversight module 104 detects a subsequent user communication whereby the user 110 expresses a negative emotion corresponding to the provided response (e.g., shock, disgust, outrage, etc.) and the autonomous ethical oversight module 104 determines that the previously provided response includes objectionable content (e.g., illicit content, violent content, content that does not comport with applicable rules and/or standards, etc.), the autonomous ethical oversight module 104 may update or otherwise retrain the generalized autonomous intelligent agent 102 and/or the domain-specific AI models 106 to remove such objectionable content from future responses for the user 110.

In an embodiment, the generalized autonomous intelligent agent 102 further implements a self-assessment and improvement loop (SAIL) or other feedback loop whereby the generalized autonomous intelligent agent 102 may automatically evaluate its performance, identifies areas for improvement, and autonomously applies updates to improve its performance. For instance, using SAIL, the generalized autonomous intelligent agent 102 may evaluate user feedback to provided responses and accordingly annotate these responses in order to refine its capabilities in processing user prompts and evaluating responses prior to dissemination to users over time. For instance, as feedback is obtained from myriad users over time, the generalized autonomous intelligent agent 102 may identify a need for new domain-specific AI models associated with new knowledge domains, as these new domain-specific AI models may be required to address changing contexts. Accordingly, using SAIL, the generalized autonomous intelligent agent 102 may access external data sources to obtain additional reference materials according to the identified knowledge domains to implement and dynamically train these new domain-specific AI models. Thus, as the generalized autonomous intelligent agent 102 and the domain-specific AI models 106 process different user prompts associated with different users and according to generated emotion-based response strategies, the generalized autonomous intelligent agent 102 may dynamically retrain and/or reinforce itself and the domain-specific AI models 106 through the aforementioned methodologies.

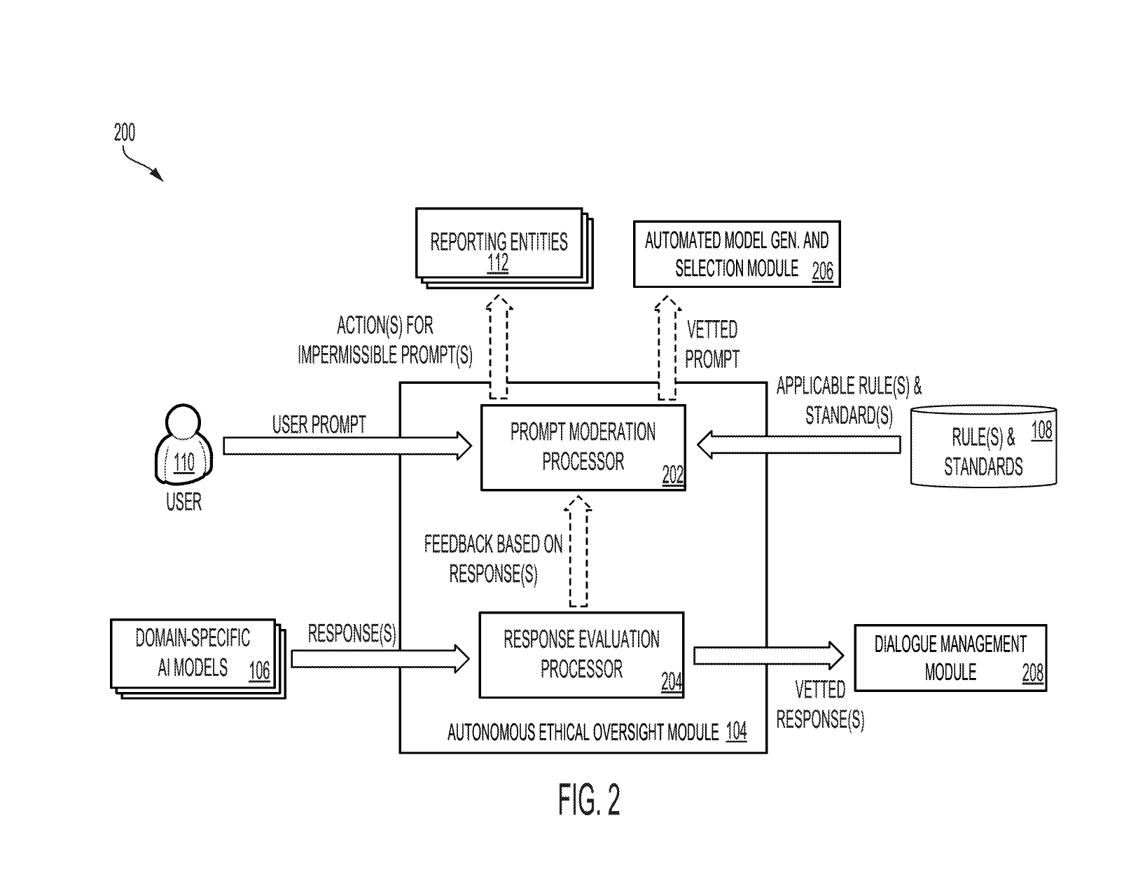

FIG. 2 shows an illustrative example of an environment 200 in which an autonomous ethical oversight module 104 implemented by a generalized autonomous intelligent agent dynamically processes user prompts and responses from different domain-specific AI models 106 to identify impermissible intents and tailor responses according to applicable rules and standards in accordance with at least one embodiment. In the environment 200, the autonomous ethical oversight module 104, through a prompt moderation processor 202, may receive a user prompt. The prompt moderation processor 202, in an embodiment, is configured to dynamically process user prompts according to any applicable rules and/or standards to determine whether these user prompts may be processed by the generalized autonomous intelligent agent and domain-specific AI models 106 to generate responses to these user prompts.

In an embodiment, in response to receiving a user prompt associated with the user 110, the prompt moderation processor 202 queries a rules and standards repository 108 to identify any applicable rules and/or standards that may be implemented to determine whether the user prompt is associated with a permissible intent. The prompt moderation processor 202, in response to receiving the user prompt, may apply NLP techniques (such as NER) to automatically parse the user prompt to identify particular terms that may be used to determine an intent expressed by the user 110.

To identify the applicable rules and/or standards that may be implemented to evaluate received user prompts associated with the user 110, the prompt moderation processor 202 may identify one or more user characteristics associated with the user 110. For instance, when the user 110 initiates a communications session with the generalized autonomous intelligent agent 102, the prompt moderation processor 202 may assess the user’s role within an organization or other entity to identify the rules and standards that may be applicable to any user prompts submitted by the user 110. The prompt moderation processor 202, through an authentication layer, may evaluate a user profile associated with the user 110 to detect the user’s role within an organization or other entity and, based on this role, identify the applicable rules and/or standards from the rules and standards repository 108. As noted above, the authentication layer may be implemented using a common user database that provides login simplicity for users and to further reinforce a user interaction code of conduct, whereby users may be held accountable for their interactions with the generalized autonomous intelligent agent 102 such as through limitations of use, suspensions, and the like. Thus, through the common user database, the prompt moderation processor 202 may identify the organization or other entity that the user 110 is associated with, the user’s role within the organization or other entity, the user’s location, and any other user characteristics that may be used to identify any applicable rules and/or standards from the rules and standards repository 108.

In an embodiment, the prompt moderation processor 202 may process the received user prompt according to the applicable rules and/or standards obtained from the rules and standards repository 108 to determine whether the user prompt may be processed by the generalized autonomous intelligent agent and the domain-specific AI models 106. For instance, if the prompt moderation processor 202 determines that the intent extracted from the user prompt does not comport with the applicable ethical rules and standards, the prompt moderation processor 202 may determine what actions may be taken as a result of the impermissible prompt. For example, as illustrated in FIG. 1, the autonomous ethical oversight module 104 may transmit, to one or more reporting entities 112, an indication that the user 110 has submitted a user prompt corresponding to an impermissible intent. The one or more reporting entities 112 may be identified according to the applicable rules and/or standards and any user characteristics associated with the user 110. In some instances, if the user 110 submits an impermissible user prompt, the prompt moderation processor 202 may use the aforementioned authentication layer to update the common user database implemented through the authentication layer to suspend the user, limit the user’s interactions with the generalized autonomous intelligent agent 102, or otherwise perform any required disciplinary action.

If the prompt moderation processor 202 determines that the user prompt is associated with a permissible intent and may be processed by the generalized autonomous intelligent agent 102 and the domain-specific AI models 106, the prompt moderation processor 202 may transmit the user prompt to an automated model generation and selection module 206 implemented by the generalized autonomous intelligent agent to generate one or more responses to the user prompt. Additionally, in some instances, the prompt moderation processor 202 may transmit the rules and/or standards identified as being applicable to the user prompt. The automated model generation and selection module 206 may dynamically generate and maintain domain-specific AI models 106 that are dynamically trained to provide responses to user prompts associated with specific knowledge distillation techniques. For instance, the automated model generation and selection module 206 implements one or more AutoML systems to generate different domain-specific AI models 106 corresponding to different knowledge domains and that are trained using different resources from external data sources. Through these external data sources, the automated model generation and selection module 206 may access different sources of knowledge to obtain reference texts and manuals, domain-specific databases, training datasets, etc. that may be used to dynamically train these one or more domain-specific AI models 106.

The automated model generation and selection module 206 may organize the set of domain-specific AI models 106 according to different clusters or committees that correspond to specific knowledge domains or other areas of influence. To maintain these different clusters or committees, the automated model generation and selection module 206 may assign specific keywords or disciplines to the different clusters or committees in order to maintain a clear division of labor amongst the different domain-specific AI models 106. Each domain-specific AI model assigned to a particular cluster or committee may be associated with the specific keywords or disciplines such that, when the automated model generation and selection module 206 selects a particular cluster or committee to review a given prompt and generate a response to the prompt, the prompt may be provided to each of the domain-specific AI models 106 assigned to the cluster or committee.

In response to the user prompt, the automated model generation and selection module 206 may convert the user prompt into a set of prompt embeddings. The automated model generation and selection module 206 may compare the set of prompt embeddings to the specific keywords or disciplines assigned to each cluster or committee of domain-specific AI models to identify the appropriate cluster or committee of domain-specific AI models that may be leveraged to generate a response to the user prompt. Once the automated model generation and selection module 206 has identified the appropriate cluster or committee of domain-specific AI models for processing of the user prompt, the automated model generation and selection module 206 may transmit the user prompt to each of the domain-specific AI models associated with the cluster or committee to solicit responses to the user prompt. The different domain-specific AI models 106 within the cluster or committee may collaboratively process the user prompt according to their individual knowledge domains to generate a cohesive and comprehensive response to the user prompt. Further, each domain-specific AI model may review and refine any outputs generated by the different domain-specific AI models within a cluster or committee to ensure response accuracy. In some instances, the automated model generation and selection module 206 may further provide the set of applicable rules and/or standards to the different domain-specific AI models 106. This may allow the different domain-specific AI models 106 to apply these rules and/or standards when generating responses to the user prompt.

As noted above, the execution of the different domain-specific AI models 106 of a particular cluster or committee may be performed in parallel such that each domain-specific AI model may simultaneously process a user prompt according to its corresponding knowledge domain. The outputs from each of these domain-specific AI models may be circulated within the cluster or committee according to the world knowledge graph to further refine these outputs and/or leverage these outputs to converge towards a finalized response to the user prompt. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains.

In an embodiment, and as illustrated in FIG. 2, responses generated by the different domain-specific AI models 106 are processed by a response evaluation processor 204 implemented by the autonomous ethical oversight module 104 to determine whether these responses comport with the rules and/or standards applicable to the user prompt. The response evaluation processor 204 may perform emotion-informed risk assessment to consider emotional aspects when evaluating risks and potential outcomes from providing the generated response to the user 110. For instance, as noted above, a given response may present possible ethical dilemmas whereby, based on a user profile corresponding to the user 110, the response evaluation processor 204 may determine that providing the generated response could result in possible self-harm or other forms of harm (e.g., harm or violence to others, violation of applicable laws and regulations, violation of workplace policies, etc.). Accordingly, the response evaluation processor 204 may modify the response to remove any information or other data that may be problematic.

In an embodiment, the response evaluation processor 204 transmits feedback corresponding to the responses obtained from the domain-specific AI models 106 to the prompt moderation processor 202. This feedback may denote any modifications made to the responses generated by the domain-specific AI models 106 based on the applicable rules and/or standards and on any evaluations performed by the response evaluation processor 204 to identify ethical dilemmas or other problematic data presented through the received responses. The prompt moderation processor 202 may provide this feedback to the automated model generation and selection module 206, which may use this feedback to dynamically retrain or otherwise update the domain-specific AI models 106 to generate responses to user prompts according to the applicable rules and/or standards and that omit any problematic data. The feedback from the response evaluation processor 204 may further be used by the prompt moderation processor 202 to update its own processes in order to allow better recognition of impermissible intents or of user prompts that may result in problematic responses.

Once the response evaluation processor 204 has finalized a response for delivery to the user 110, the response evaluation processor 204 may provide this finalized, vetted response to a dialogue management module 208 implemented by the generalized autonomous intelligent agent for communication to the user 110. In an embodiment, the dialogue management module 208 monitors subsequent user communications to obtain feedback with regard to provided response. The dialogue management module 208 may provide this feedback to a self-assessment and improvement module implemented by the generalized autonomous intelligent agent, which continuously executes CRL using FMAL to further reinforce and/or update the different modules of the generalized autonomous intelligent agent (including the autonomous ethical oversight module 104) and the domain-specific AI models 106. Returning to an earlier illustrative example, if the response evaluation processor 204 detects a subsequent user prompt that is violative of one or more applicable rules and/or standards and the subsequent user prompt is related to the previously provided response, the response evaluation processor 204 may determine that the previously provided response included one or more elements that were problematic and that should have been removed from the previously provided response. As another illustrative example, if the response evaluation processor 204 detects a subsequent user communication whereby the user 110 expresses a negative emotion corresponding to the provided response (e.g., shock, disgust, outrage, etc.) and the response evaluation processor 204 determines that the previously provided response includes objectionable content (e.g., illicit content, violent content, content that does not comport with applicable rules and/or standards, etc.), the response evaluation processor 204 may update or otherwise retrain the prompt moderation processor 202 and/or the domain-specific AI models 106 to remove such objectionable content from future responses for the user 110. This process of self-assessment and improvement based on obtained feedback may be performed using SAIL or other feedback loop, as described above.

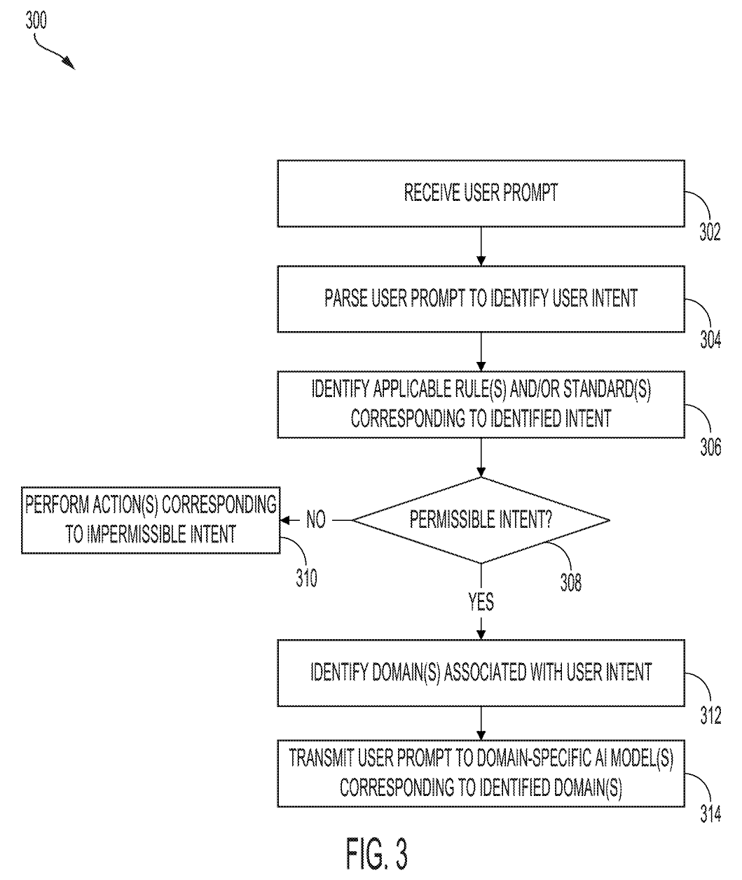

FIG. 3 shows an illustrative example of a process 300 for dynamically evaluating received user prompts to identify corresponding intents and determine whether to process these prompts according to any applicable rules and standards in accordance with at least one embodiment. The process 300 may be performed by a generalized autonomous intelligent agent that implements an autonomous ethical oversight module for vetting user prompts according to applicable rules and standards before the user prompt can be processed by the generalized autonomous intelligent agent and a set of domain-specific AI models.

At step 302, the generalized autonomous intelligent agent may receive a user prompt from a user during an ongoing communications session between the user and the generalized autonomous intelligent agent. As noted above, the generalized autonomous intelligent agent may be integrated with an agent interface through which users may begin submitting new prompts. The agent interface may be implemented through a web portal and/or native application executing on a user computing device. Through the agent interface, the user may submit their prompt for, or otherwise interact with, the generalized autonomous intelligent agent.

At step 304, the generalized autonomous intelligent agent may parse the user prompt to identify the user’s expressed intent. For instance, when the generalized autonomous intelligent agent receives a new user prompt from the user, the generalized autonomous intelligent agent may process the new user prompt through NLP techniques to identify any keywords, phrases, or other terms that may be indicative of the user’s expressed intent.

At step 306, the generalized autonomous intelligent agent, through the autonomous ethical oversight module, may identify any applicable rules and/or standards corresponding to the identified intent and/or to the user associated with the user prompt. For instance, the autonomous ethical oversight module may access a rules and standards repository to identify and obtain any applicable rules and/or standards that may be used to evaluate the user prompt. The rules and standards maintained within the rules and standards repository may specify what intents may be processed by the generalized autonomous intelligent agent as well as any actions that may be performed in the event that a user submits an impermissible prompt through the agent interface. These ethical rules or standards may be specific to certain users or user characteristics. For example, these ethical rules or standards may correspond to the location of the user (e.g., the ethical rules or standards may correspond to local laws and regulations, etc.). As another example, these ethical rules or standards may correspond to a user’s organization (i.e., employer, etc.). In some instances, the ethical rules or standards may correspond to specific intents that may have questionable or harmful ethical and/or moral ramifications (e.g., self-harm, significant potential for harm to others, etc.). In some instances, the applicable ethical rules and standards may be determined based on the user’s particular role. For instance, when the user initiates a communications session with the generalized autonomous intelligent agent, the generalized autonomous intelligent agent may assess the user’s role within an organization or other entity to identify the rules and standards that may be applicable to any user prompts submitted by the user. The user characteristics used to identify any applicable rules or standards may be determined through an authentication layer implemented using a common user database that provides login simplicity for users and to further reinforce a user interaction code of conduct, whereby users may be held accountable for their interactions with the generalized autonomous intelligent agent 102 such as through limitations of use, suspensions, and the like. Through this authentication layer, the generalized autonomous intelligent agent may access a user profile associated with the user to discern these user characteristics.

At step 308, the autonomous ethical oversight module may determine whether the received user prompt is associated with a permissible intent according to the identified rules and/or standards. If the autonomous ethical oversight module determines that the user prompt is not associated with a permissible intent based on the applicable rules and/or standards, the autonomous ethical oversight module, at step 310, may perform one or more actions corresponding to the impermissible intent. For example, the autonomous ethical oversight module may transmit an indication that the user submitted an impermissible user prompt to one or more reporting entities that may address this impermissible user prompt. As noted above, the one or more reporting entities may be identified according to the applicable rules and/or standards and any user characteristics associated with the user. For instance, if the user prompt associated with an impermissible intent was communicated from a computing device associated with the user’s employer, the autonomous ethical oversight module may automatically transmit a notification to this employer to indicate the submission of this user prompt. This may allow the employer to address the user’s submission of an impermissible user prompt. In some instances, if the autonomous ethical oversight module determines that the user prompt is associated with an impermissible intent corresponding to illicit activity, the autonomous ethical oversight module may transmit a notification to law enforcement agencies that may address the user’s submission of an impermissible user prompt. In some instances, if the user submits an impermissible user prompt, the autonomous ethical oversight module may use the aforementioned authentication layer to update the common user database implemented through the authentication layer to suspend the user, limit the user’s interactions with the generalized autonomous intelligent agent, or otherwise perform any required disciplinary action.

If the user prompt is associated with a permissible intent (as determined based on the applicable rules and/or standards), the generalized autonomous intelligent agent, at step 312, may identify the one or more knowledge domains associated with the user intent. As noted above, the generalized autonomous intelligence agent may maintain a world knowledge graph representation of the different clusters or committees of domain-specific AI models that may be leveraged to generate responses to user prompts. This world knowledge graph may be implemented through a data structure that represents the different domain-specific AI models maintained by the generalized autonomous intelligent agent as individual nodes and any corresponding relationships among these models using edges. The world knowledge graph may further denote the different domains or other areas of influence associated with each of these individual nodes, which may be used to define the different clusters or committees of domain-specific AI models implemented by the generalized autonomous intelligent agent. Thus, using this world knowledge graph according to the identified intent, the generalized autonomous intelligent agent may identify the one or more domains associated with this intent.

At step 314, the generalized autonomous intelligent agent may transmit the user prompt to the domain-specific AI models corresponding to the identified knowledge domains. For instance, based on the identified domains, the generalized autonomous intelligent agent may identify a domain-specific AI model cluster or committee comprising a set of domain-specific AI models that may collectively and collaboratively generate one or more responses to the user prompt. The domain-specific AI models associated with a particular cluster or committee may individually process an obtained user prompt to generate a response according to the knowledge domain of the domain-specific AI model. Further, the individual domain-specific AI models may evaluate the world knowledge graph to provide any outputs to other domain-specific AI models within the cluster or committee that may require these outputs in order to generate additional outputs responsive to the user prompt. This process allows the different domain-specific AI models within a cluster or committee to collaboratively process a user prompt according to their individual knowledge domains to generate a cohesive and comprehensive response to the user prompt. Further, each domain-specific AI model may review and refine any outputs generated by the different domain-specific AI models within a cluster or committee to ensure response accuracy. In some instances, the generalized autonomous intelligent agent may further provide the set of applicable rules and/or standards to the different domain-specific AI models. This may allow the different domain-specific AI models to apply these rules and/or standards when generating responses to the user prompt.

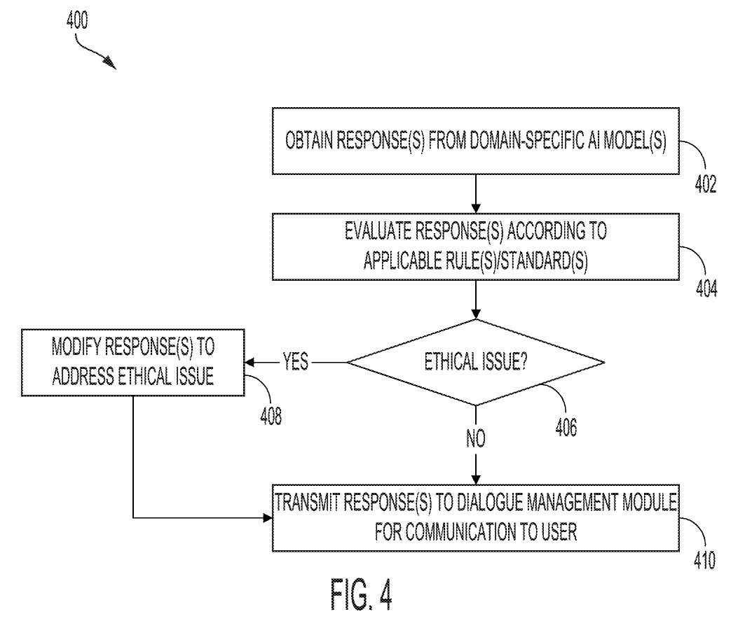

FIG. 4 shows an illustrative example of a process 400 for dynamically evaluating responses generated by different domain-specific AI models to determine whether to modify the responses according to any applicable rules or standards prior to providing a tailored response to a user prompt in accordance with at least one embodiment. The process 400 may be performed by the generalized autonomous intelligent agent that implements an autonomous ethical oversight module for vetting responses generated by different domain-specific AI models according to applicable rules and standards.

At step 402, the generalized autonomous intelligent agent may obtain a set of responses from a set of domain-specific AI models to which a user prompt was provided. As noted above, the execution of the set of domain-specific AI models is performed in parallel such that each domain-specific AI model may simultaneously process a user prompt according to its corresponding knowledge domain. The outputs from each of these domain-specific AI models may be circulated within the cluster or committee according to the world knowledge graph to further refine these outputs and/or leverage these outputs to converge towards a finalized response to the user prompt. As these outputs are refined and finalized, the outputs may be transmitted by the set of domain-specific AI models to a response evaluation processor of the autonomous ethical oversight module.

At step 404, the response evaluation processor of the autonomous ethical oversight module may evaluate these obtained responses according to any applicable rules and/or standards to determine, at step 406, whether there is an ethical issue or other issue that may preclude transmission of a response to the user. For instance, the response evaluation processor may perform emotion-informed risk assessment to consider emotional aspects when evaluating risks and potential outcomes from providing the generated response to the user. As noted above, a given response may present possible ethical dilemmas whereby, based on a user profile corresponding to the user, the response evaluation processor may determine that providing the generated response could result in possible self-harm or other forms of harm (e.g., harm or violence to others, violation of applicable laws and regulations, violation of workplace policies, etc.). Accordingly, the response evaluation processor, at step 408, may modify the response to remove any information or other data that may be problematic.

If the responses do not present an ethical issue, or are otherwise modified to address an identified ethical issue, the response evaluation processor, at step 410, may transmit the one or more responses to a dialogue management module of the generalized autonomous intelligent agent to transmit a finalized response to the user. As noted above, the dialogue management module monitors subsequent user communications to obtain feedback with regard to provided response. The dialogue management module may provide this feedback to a self-assessment and improvement module implemented by the generalized autonomous intelligent agent, which continuously executes CRL using FMAL to further reinforce and/or update the different modules of the generalized autonomous intelligent agent (including the autonomous ethical oversight module) and the domain-specific AI models.

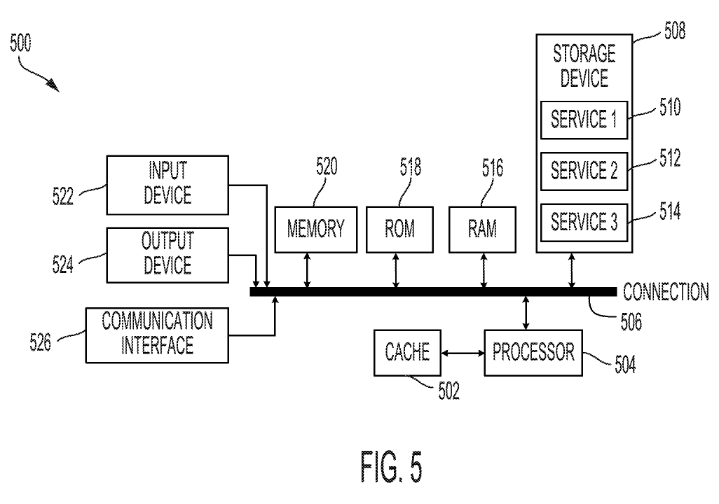

FIG. 5 illustrates a computing system architecture 500 including various components in electrical communication with each other using a connection 506, such as a bus, in accordance with some implementations. Example system architecture 500 includes a processing unit (CPU or processor) 504 and a system connection 506 that couples various system components including the system memory 520, such as ROM 518 and RAM 516, to the processor 504. The system architecture 500 can include a cache 502 of high-speed memory connected directly with, in close proximity to, or integrated as part of the processor 504. The system architecture 500 can copy data from the memory 520 and/or the storage device 508 to the cache 502 for quick access by the processor 504. In this way, the cache can provide a performance boost that avoids processor 504 delays while waiting for data. These and other modules can control or be configured to control the processor 504 to perform various actions.

Other system memory 520 may be available for use as well. The memory 520 can include multiple different types of memory with different performance characteristics. The processor 504 can include any general purpose processor and a hardware or software service, such as service 1510, service 2512, and service 3514 stored in storage device 508, configured to control the processor 504 as well as a special-purpose processor where software instructions are incorporated into the actual processor design. The processor 504 may be a completely self-contained computing system, containing multiple cores or processors, a bus, memory controller, cache, etc. A multi-core processor may be symmetric or asymmetric.

To enable user interaction with the computing system architecture 500, an input device 522 can represent any number of input mechanisms, such as a microphone for speech, a touch-sensitive screen for gesture or graphical input, keyboard, mouse, motion input, speech and so forth. An output device 524 can also be one or more of a number of output mechanisms known to those of skill in the art. In some instances, multimodal systems can enable a user to provide multiple types of input to communicate with the computing system architecture 500. The communications interface 526 can generally govern and manage the user input and system output. There is no restriction on operating on any particular hardware arrangement and therefore the basic features here may easily be substituted for improved hardware or firmware arrangements as they are developed.

Storage device 508 is a non-volatile memory and can be a hard disk or other types of computer readable media which can store data that are accessible by a computer, such as magnetic cassettes, flash memory cards, solid state memory devices, digital versatile disks, cartridges, RAMs 516, ROM 518, and hybrids thereof.

The storage device 508 can include services 510, 512, 514 for controlling the processor 504. Other hardware or software modules are contemplated. The storage device 508 can be connected to the system connection 506. In one aspect, a hardware module that performs a particular function can include the software component stored in a computer-readable medium in connection with the necessary hardware components, such as the processor 504, connection 506, output device 524, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
detecting a user prompt associated with a user, wherein the user prompt is received during an ongoing communications session between a user and a generalized autonomous intelligent agent;
processing the user prompt through the generalized autonomous intelligent agent to detect an intent;
identifying a set of applicable rules corresponding to different intents, wherein the set of applicable rules defines one or more impermissible intents and one or more ethical limitations associated with a set of user characteristics corresponding to the user;
transmitting the user prompt to a set of domain-specific artificial intelligence models to solicit a response to the user prompt, wherein the user prompt is transmitted as a result of the intent not corresponding to the one or more impermissible intents, and wherein when the user prompt is received by the set of domain-specific artificial intelligence models, the set of domain-specific artificial intelligence models collaboratively processes the user prompt to generate a set of responses;
modifying the set of responses according to the set of applicable rules to generate a tailored response, wherein the tailored response is devoid of content corresponding to the one or more ethical limitations; and
updating an interface associated with the ongoing communications session to provide the tailored response.

2. The computer-implemented method of claim 1, further comprising:
detecting a new user prompt, wherein the new user prompt corresponds to an impermissible intent; and
automatically rejecting the new user prompt, wherein the new user prompt is automatically rejected based on the impermissible intent and the set of applicable rules.

3. The computer-implemented method of claim 1, wherein the one or more ethical limitations correspond to permissible locations from which user prompts corresponding to the intent are processable, and wherein the user prompt is transmitted to the set of domain-specific artificial intelligence models as a result of the user prompt being submitted from a permissible location.

4. The computer-implemented method of claim 1, wherein the one or more ethical limitations correspond to permissible user organizations authorized to submit user prompts corresponding to the intent, and wherein the user prompt is transmitted to the set of domain-specific artificial intelligence models as a result of the user being associated with a permissible user organization.

5. The computer-implemented method of claim 1, further comprising:
detecting a new user prompt, wherein the new user prompt corresponds to an impermissible intent; and
disabling further user interaction with the generalized autonomous intelligent agent as a result of the new user prompt corresponding to the impermissible intent.

6. The computer-implemented method of claim 1, further comprising:
detecting a new user prompt, wherein the new user prompt corresponds to an impermissible intent; and
transmitting the new user prompt to one or more external entities to address the impermissible intent.

7. The computer-implemented method of claim 1, wherein modifying the set of responses further comprises:
performing an emotion-informed risk assessment of the set of responses to identify one or more emotional aspects associated with the set of responses; and
modifying the set of responses according to the one or more emotional aspects.

8. A system, comprising:
one or more processors; and
memory storing thereon instructions that, as a result of being executed by the one or more processors, cause the system to:
detect a user prompt associated with a user, wherein the user prompt is received during an ongoing communications session between a user and a generalized autonomous intelligent agent;
process the user prompt through the generalized autonomous intelligent agent to detect an intent;
identify a set of applicable rules corresponding to different intents, wherein the set of applicable rules defines one or more impermissible intents and one or more ethical limitations associated with a set of user characteristics corresponding to the user;
transmit the user prompt to a set of domain-specific artificial intelligence models to solicit a response to the user prompt, wherein the user prompt is transmitted as a result of the intent not corresponding to the one or more impermissible intents, and wherein when the user prompt is received by the set of domain-specific artificial intelligence models, the set of domain-specific artificial intelligence models collaboratively processes the user prompt to generate a set of responses;
modify the set of responses according to the set of applicable rules to generate a tailored response, wherein the tailored response is devoid of content corresponding to the one or more ethical limitations; and
update an interface associated with the ongoing communications session to provide the tailored response.

9. The system of claim 8, wherein the instructions further cause the system to:
detect a new user prompt, wherein the new user prompt corresponds to an impermissible intent; and
automatically reject the new user prompt, wherein the new user prompt is automatically rejected based on the impermissible intent and the set of applicable rules.

10. The system of claim 8, wherein the one or more ethical limitations correspond to permissible locations from which user prompts corresponding to the intent are processable, and wherein the user prompt is transmitted to the set of domain-specific artificial intelligence models as a result of the user prompt being submitted from a permissible location.

11. The system of claim 8, wherein the one or more ethical limitations correspond to permissible user organizations authorized to submit user prompts corresponding to the intent, and wherein the user prompt is transmitted to the set of domain-specific artificial intelligence models as a result of the user being associated with a permissible user organization.

12. The system of claim 8, wherein the instructions further cause the system to:
detect a new user prompt, wherein the new user prompt corresponds to an impermissible intent; and
disable further user interaction with the generalized autonomous intelligent agent as a result of the new user prompt corresponding to the impermissible intent.

13. The system of claim 8, wherein the instructions further cause the system to:
detect a new user prompt, wherein the new user prompt corresponds to an impermissible intent; and
transmit the new user prompt to one or more external entities to address the impermissible intent.

14. The system of claim 8, wherein instructions that cause the system to modify the set of responses further cause the system to:
perform an emotion-informed risk assessment of the set of responses to identify one or more emotional aspects associated with the set of responses; and
modify the set of responses according to the one or more emotional aspects.

15. A non-transitory computer-readable storage medium storing thereon executable instructions that, as a result of being executed by one or more processors of a computer system, cause the computer system to:
detect a user prompt associated with a user, wherein the user prompt is received during an ongoing communications session between a user and a generalized autonomous intelligent agent;
process the user prompt through the generalized autonomous intelligent agent to detect an intent;
identify a set of applicable rules corresponding to different intents, wherein the set of applicable rules defines one or more impermissible intents and one or more ethical limitations associated with a set of user characteristics corresponding to the user;
transmit the user prompt to a set of domain-specific artificial intelligence models to solicit a response to the user prompt, wherein the user prompt is transmitted as a result of the intent not corresponding to the one or more impermissible intents, and wherein when the user prompt is received by the set of domain-specific artificial intelligence models, the set of domain-specific artificial intelligence models collaboratively processes the user prompt to generate a set of responses;
modify the set of responses according to the set of applicable rules to generate a tailored response, wherein the tailored response is devoid of content corresponding to the one or more ethical limitations; and
update an interface associated with the ongoing communications session to provide the tailored response.

16. The non-transitory computer-readable storage medium of claim 15, wherein the executable instructions further cause the computer system to:
detect a new user prompt, wherein the new user prompt corresponds to an impermissible intent; and
automatically reject the new user prompt, wherein the new user prompt is automatically rejected based on the impermissible intent and the set of applicable rules.

17. The non-transitory computer-readable storage medium of claim 15, wherein the one or more ethical limitations correspond to permissible locations from which user prompts corresponding to the intent are processable, and wherein the user prompt is transmitted to the set of domain-specific artificial intelligence models as a result of the user prompt being submitted from a permissible location.

18. The non-transitory computer-readable storage medium of claim 15, wherein the one or more ethical limitations correspond to permissible user organizations authorized to submit user prompts corresponding to the intent, and wherein the user prompt is transmitted to the set of domain-specific artificial intelligence models as a result of the user being associated with a permissible user organization.

19. The non-transitory computer-readable storage medium of claim 15, wherein the executable instructions further cause the computer system to:
detect a new user prompt, wherein the new user prompt corresponds to an impermissible intent; and
disable further user interaction with the generalized autonomous intelligent agent as a result of the new user prompt corresponding to the impermissible intent.

20. The non-transitory computer-readable storage medium of claim 15, wherein the executable instructions further cause the computer system to:
detect a new user prompt, wherein the new user prompt corresponds to an impermissible intent; and
transmit the new user prompt to one or more external entities to address the impermissible intent.

21. The non-transitory computer-readable storage medium of claim 15, wherein executable instructions that cause the computer system to modify the set of responses further cause the computer system to:
perform an emotion-informed risk assessment of the set of responses to identify one or more emotional aspects associated with the set of responses; and
modify the set of responses according to the one or more emotional aspects.
